(19) United States
(12) Patent Application Publication
(10) Pub. No.: US 2017/0334733 A1
(43) Pub. Date: Nov. 23, 2017

(54) Method of Salts Cleaning from Higher Solubility Impurities by Virtue of Homogenization Thereof with a Solvent at a Constant Temperature

(71) Applicants: Yehuda MAZUZ, Bnei Brak (IL); GREEN HYDROMETALLURGY PROCESSING LTD., Tel Aviv (IL)

(72) Inventor: Solomon FLAKS, Rishon Lezion (IL)

(21) Appl. No.: 15/520,920

(22) PCT Filed: Oct. 21, 2015
(86) PCT No.: PCT/IL2015/000047

§ 371 Date: Apr. 21, 2017

(30) Foreign Application Priority Data
Oct. 23, 2014 (IL) 235306

(51) Int. Cl. C01D 3/14; B01D 11/04; B01D 9/00

(52) U.S. Cl. CPC C01D 3/14; B01D 9/0004; B01D 11/04

(57) ABSTRACT

Set forth herein is a new method of salts cleaning from higher solubilization impurities by virtue of homogenization thereof with a solvent until the obtainment of a uniform suspension and curing thereof at a constant temperature, whereby the solubility factors delta for the salts subject to separation is the highest, the salt thus cleaned being then filtered and separated from the contaminated mother solution, the latter to be recirculated to the initial point of the process for further extraction of all the remaining components of the mix.

This invention pertains to the domain of pure and ultrapure salts production to be used in the chemical, metallurgical and food industries as well as in the production of medicines, cosmetics, etc.

There exist several methods of salts purification treatment. One of such methods consists in solubilizing a salt in water or in an organic solvent in a heating exposure environment or at room temperature, the solution thus obtained to be cleaned from impurities with the help of an ion-exchange resin, by way of extraction or using some other method, whereupon the resulting purified solution is subjected to concentration by vaporization and cold crystallization, which makes it possible to obtain impurities-free crystalline salt.

The method of salts cleaning most widely used at present is based on impure salts recrystallization, whereby the salts are first solubilized in a heating exposure environment, the saturated brine being then cooled down and crystallized. The crystals of salt thus cleaned are more pure since all the other salts, having higher solubility properties than the basic salt, remain entrapped in the mother solution. If need be, this operation is repeated several times. The Wikipedia Internet resource specifies that both the crystallization and recrystallization processes comprise five stages as follows: 1) Salt melting down in a minimum volume boiling solvent (saturated solution preparation stage). 2) Hot solution filtration with a view to removing insoluble impurities (given, those are present). 3) Solution/crystals formed cooling down. 4) Crystals' separation from the mother solution using filtration. 5) Crystals drying.

In case of the multiple recrystallization process, the 5^{th} stage of the process, i.e. crystals drying, is only to be performed after end-product recrystallization. Thus, for instance, the process of cleaning potassium fluorozirconate K₂ZrF₆ from potassium fluorohafnate K₂HfF₆ requires 16 recrystallization cycles, no resulting saturated hot solutions filtration upon each solubilization being conducted, only totally purified crystals herewith undergoing a drying exposure at the end of the process (Meyerson G. A), Zalikman A. N. “Rare Metals Metallurgy”, M. 1955). Such multiple solubilizations with a subsequent stage of crystals cooling down/filtration after each cycle are really labor-/energy-intense.

The aim of this invention is the development of an economical process for cleaning salts from soluble impurities, making it possible to implement the process at a constant, basically room, temperature, neither salts solution exposure to a high temperature environment, nor follow-up low-temperature crystallization being required.

The above stated objective is to be achieved by virtue of adding a solvent to the solution mix to be cleaned, the volume of such solvent being sufficient to dissolve the impurities, with the mixture to be homogenized until the obtainment of a uniform suspension. The homogenization process is to be implemented using standard production equipment: rotor-type centrifugal homogenizers, ball crusher mills, grinders, etc., assuring the obtainment of a uniform suspension, the crystal particles thereof having a size of 1 micron and a large surface area. Typically, the production of crystals with such parameters involves chafing for no more than 30 minutes, within which time a balance between the particles composition and that of the brine will be achieved on an analogy with the equilibrium peculiar to the classical recrystallization method. Upon the completion of the homogenization process, the resulting suspension is to be filtered in order to separate the crystals purified from the mother solution. If need be, the process is to be repeated several times.

However, with each rinsing operation, part of the salt is lost (washed away). With a view to reducing such losses and achieving a higher salt extraction rate, the mother solution, upon the second rinsing thereof, is to be used, based on the counter-flow principle, for the first rinsing of the next batch of salt, the follow-up third-rinsing solution to be used for the second-rinsing solution and so on.

Such a method makes it possible to achieve a maximum rate of salt extraction with the required purity of the end product. Apart from that, in performing the counter-flow rinsing, the first mother solution is characterized by an increased impurities content, which makes such a solution suitable for other salts extraction.

The method proposed herein was test-operated on a pilot plant provided by the GHP Company.

### EXAMPLE 1

The study was based on the use of the saliferous brine of the Israeli de-salination plant “Palmakhim”, which is currently being waste-dumped into the sea.

Using the plant of the GHP Company, 500 liters of Palmakhim's brine yielded 490 l of fresh water, 2.9 kg of plaster-stone, (CaSO₄·2H₂O), 7.65 liters of MgCl₂ saturated brine, containing 4.000 g of MgCl₂, 20 g of NaCl, 10 g of KCl (99.25% of MgCl₂; 0.5% of NaCl; 0.25% of KCl) and 31 kg of a wet salts mix, containing 5% of H₂O and, in terms of dry weight, MgCl₂—0.4%, KCl—2.54%, NaCl—96.93%, which required the application of a salts separation process.

At the first stage, the salt was cleaned from an impurity characterized by a very high solubility, i.e. from magnesium. The salts separation process was performed at a temperature of 25° C.*. Salts solubility rates at this temperature (A Chemist's Reference Book, T3, Moscow-Leningrad, 1964) are as follows: MgCl₂—585 g/l; NaCl—360 g/l; Kcl—360 g/l.

At the 1^{st} cleaning stage, 1.5 l of distilled water was added to the wet salt, the resulting mix having been then processed in a disk grinder, the suspension thus obtained being thereupon agitation-cured for 30 minutes and filtered using a vacuum nutsch-filter. The filtration operation yielded 1.45 l of brine containing MgCl₂—45 g/l; KCl—10 g/l; NaCl—310 g/l, as well as 30.45 kg of wet salt (5% H₂O), cleaned from magnesium, comprising MgCl₂—0.18%; KCl—2.54%; NaCl—97.28%.

The brine in the amount of 1.45 liters was recirculated to the initial stage of the process for an ultimate extraction of MgCl₂ and other impurities as well as for the solvent regeneration.

At the second stage, sodium chloride was cleaned from KCl, whose content was just 2.54%. Such a low content of KCl makes it possible to separate the salts by virtue of converting potassium chloride into a liquid state and obtaining a less soluble NaCl salt in a solid state. The solubility table data showed that the highest solubility delta for the salts to be separated occurs at a temperature of 100° C. and makes for KCl—560 g/l, for NaCl—394 g/l, ΔM=166 g/l.

For purposes of separating KCl and NaCl, the magnesium-free wet salt was blended with 1.5 l of distilled water, the resulting mix being then processed in a disk-grinder at room temperature and agitation-cured in the mixer for 30 minutes at t=100° C., whereupon the pulp thus obtained was filtered.

Entrapped in the filter was sodium chloride in the amount of 28.06 kg, in terms of the composition dry weight: NaCl—99.99%; KCl—6·10⁻³%, MgCl₂—1·10⁻⁴%. The filtered material in the amount of 1.43 l was cooled down to a temperature of −2.3° C. for KCl crystallization, whereupon the KCl crystals were separated from the mother solution by way of filtration. The resulting KCl crystals' weight was 734.8 g with a composition as follows: KCl—98.1%; MgCl₂—0.004%; NaCl—1.9%, KCL true output being 99.5%. The mother solution in the amount of 1.4 l and the composition of was as follows: KCl—1.3 g/l; MgCl₂—37.2 g/l; NaCl—50.2 g/l was recirculated to the beginning of the process for an ultimate extraction of all the salts and solvent regeneration. In all, recirculated to the initial stage of the process was 2.85 l of brine, which makes 0.6% of the initial quantity of the brine used in the process described herein.

### EXAMPLE 2

For conducting tests in a different temperature range, there was prepared 1 kg of an artificial mix of the NaCl and KCl salts whose composition was equivalent to natural sylvanite: KCl—30%, NaCl—70%. This mix was cleaned at a temperature of −2.3° C. In this case, (as per the table data), NaCl solubility equals 313 g/l, whereas KCl solubility is 52 g/l. However, given a high NaCl concentration, potassium chloride is practically insoluble.

With a view to implementing salts separation, 1 kg of the salts mix was blended with 0.2 l of distilled water and homogenized using a disk-grinder at room temperature, whereupon the suspension thus obtained was placed in a refrigerator for cooling down to −2.3° C. and afterwards mixed with 2.1 l of distilled water cooled down to 0° C., the resulting pulp having been then cooled down to a temperature of −2.3° C., agitated for 30 minutes and quickly filtered. The resulting product was 290 g of KCl (in terms of dry weight) with a composition as follows: KCl—99.2%, NaCl—0.8%. Also obtained was 2.2 l of mother solution having a composition as follows: NaCl—315 g/l, KCl—1.04 g/l, which can be used for obtaining pure NaCl, with an additional extraction of KCl. In the example described above, the true output of KCl end product amounted to 95.9%.

1. A method of salts cleaning from higher solubilization impurities by virtue of homogenization thereof with a solvent and curing the resulting suspension at a constant temperature.

2. The process as per claim 1, whereby the homogenization process is to be perform until the obtainment of a paste-like suspension of the salts being subject to separation and the solvent, the salt particles having a size of less than 1 micron.

3. The process as per claim 2, whereby the solvent consumption rate in performing mix homogenization is to be defined by the quantity of the most soluble impurity subject to the solubility factor thereof.

4. The process as per claim 1, whereby in performing dry salt homogenization with the solvent, additional solvent is required with a view to obtaining upon subsequent filtration of a product containing 5% of solvent, no additional solvent being required given the use of wet salt.

5. The process as per claim 1, whereby water, acid solutions/alkali liquors as well as organic solvents, etc. may be used as the process solvent.

6. The process as per claim 2, whereby upon homogenization the resulting paste is to be agitation-cured in a mixer for ≧30 minutes at a constant temperature assuring a maximum solubility of the salt to be separated.

7. The process as per claim 1, whereby in separating multi-component mixes containing in excess of two salts, after the 1^{st} salt separation, the next highest solubility salt is to be selected for separation, whereupon the process is to restart from the very beginning.

8. The process as per claim 1, whereby salts cleaning may be performed in a wide temperature range—from solvent freezing negative temperatures through high positive temperatures bringing the brines obtained to the boiling point.
